(19) United States
(12) Patent Application Publication
(10) Pub. No.: US 2009/0326998 A1
(43) Pub. Date: Dec. 31, 2009

(54) TRANSACTION RISK MANAGEMENT

(75) Inventors: Ann Watkins, Charlotte, NC (US); David Denton, Charlotte, NC (US); Joe Potuzak, Huntersville, NC (US)

Correspondence Address: TUROCY & WATSON, LLP, 127 Public Square, 57th Floor, Key Tower, CLEVELAND, OH, 44114, US

(73) Assignee: WACHOVIA CORPORATION, Charlotte, NC (US)

(21) Appl. No.: 12/163,723

(22) Filed: Jun. 27, 2008

(51) Int. Cl. G06Q 10/00; G06Q 50/00

(52) U.S. Cl. 705/7

(57) ABSTRACT

The innovation assists risk management staff within a financial institution to effectively and efficiently, establish, monitor and act upon transaction risks that may occur related to treasury services. The process can include establishing a unique customer information, their account relationships with the bank, assigning transactional exposure limits, monitoring those limits, notifying appropriate (or desired) personnel when limits are breached, and notifying customers as appropriate. Additionally, approval matrices are employed to evaluate risk associated with transaction services.

### BACKGROUND

A financial facility or ‘facility’ is a term often used to describe financial assistance programs offered by financial, e.g., lending institutions, to help companies requiring capital. Essentially, these financial assistance programs can be described as loans taken by companies. Examples of such facilities include ‘swingline’ loans and lines of credits. Oftentimes companies obtain different credit facilities from financial institutions, e.g., committed or uncommitted.

Transaction risk can occur when corporations have “operating” accounts (e.g., checking accounts/Demand Deposit Accounts) with a bank where certain products are used to move money in and out of these accounts. The products used that create transaction risk are referred to as treasury services products also known in the industry as cash management products, for example, ACH (automated clearing house), controlled disbursing and checking accounts overdraft limits. Thus, a financial institution can be exposed to transaction risk without ever setting up a credit facility (e.g., line of credit) to a company.

ACH is an electronic network used for financial transactions in the United States. In the U.S., ACH processes large volumes of both credit and debit transactions which are most often originated in batches. The rules and regulations governing the ACH network are established by regulatory authorities such as the Electronic Payments Association and the Federal Reserve Association. In years past, the ACH network has been estimated to have processed in excess of eight billion transactions with a total value of nearly $22 trillion.

ACH credit transfers most commonly include direct deposit payroll and vendor payments. Additionally, ACH direct debit transfers include consumer payments such as insurance premiums, mortgage loans, and the like. As eCommerce continues to grow in popularity, businesses are also beginning to use ACH to collect from customers online in lieu of accepting credit or debit cards.

In accordance with the rules and regulations of ACH, a financial institution is not permitted to issue an ACH transaction (e.g., debit or credit) without prior authorization from the account holder. An ACH entry starts with an account holder (or Receiver) authorizing an Originator to issue ACH debit or credit to an account. In most instances, the Originator is a company or an individual (e.g., service provider, employer).

Depending on the ACH transaction, the Originator must receive written, verbal, or electronic authorization from the Receiver. ‘Written’ authorization most often includes a signed form that gives consent on the amount, date, or even frequency of the transaction. ‘Verbal’ authorization is most often audio recorded. Alternatively, the Originator must send a receipt of the transaction details before or on the date of the transaction. An ‘electronic’ (e.g., via Internet) authorization includes a customer's electronic signature and acknowledgment of terms and conditions.

Once authorization is acquired, the Originator can create an ACH entry to be given to an Originating Depository Financial Institution (ODFI), which can be most any financial institution that is capable of performing ACH origination. The financial institution transfers this ACH entry to an ACH Operator (e.g., Fed) and is passed on to the Receiving Depository Financial Institution (RDFI), where, depending on the ACH transaction, the Receiver's account is issued either a credit or debit.

The RDFI may, however, reject the ACH transaction and return it to the ODFI with the appropriate reason, such as, for example, insufficient funds in the account or that the account holder indicated that the transaction was unauthorized. However, this process of rejection and return is traditionally labor intensive and prone to human (e.g., clerical, judgment) error.

One problem with ACH occurs when the account holder issues a stop payment on a physical check. For example, an account holder can issue a stop payment innocently, e.g., not being aware that the check was presented as an ACH entry. Other issues arise where insufficient funds exist. Today, as electronic funds transfer can lead to irregularities in fund availability, thus, potential for issues with ACH transactions. As a result, ODFI (e.g., financial institutions) are exposed to great risks with respect to these ACH transactions. While much of the risk mitigation today is manually tracked, it will be understood that these manual processes sometimes increase a financial institutions risk by exposing human errors. As well, manual tracking of ACH transactions and risk mitigation is extremely expensive in view of the manpower necessary for the manual processes used today.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system (and corresponding methodologies) that employs an enterprise- or company-wide repository for all transaction risk exposure related to commercial customers. In aspects, transaction risk occurs when commercial customers transact business/commerce with an entity (e.g., financial institution) for the purpose of moving monies either into or out of the entity (e.g., financial institution). The risk management system functions as a repository for maintaining monetary exposure on customers via accounts used for processing monies either into or out of the entity or financial institution.

Additionally, in other aspects the risk management system functions as a repository for all Borrower Default Grades (BDG) and Facility Default Grades (FDG) that are assigned to a customer and their accounts. Features of the system include, but are not limited to, the ability to accept real-time (or near real-time) and batch interfaces, performing MQ (message queue) messaging, CIM (customer interaction management) calls to other applications, calculating real time exposures, creating risk alerts, triggering electronic notifications to internal staff and external customers, automatic set up of transaction risk exposure facility requests through the use of on-line request screens and approval matrices as well as real-time (or near real-time) decisioning of risk alerts.

The innovation can include extensive logic that enables non-human intervention as it relates to approving or declining risk alerts or notifications. Additional logic can be deployed to pre-fill (or auto-fill) data values on new or renewed requests by accessing the transaction risk exposure system repository as well as performing CIM calls and application extracts in acquiring the pertinent data.

In yet another aspect thereof, artificial intelligence and machine learning & reasoning components can be provided that employ probabilistic and/or statistical-based analysis to prognose or infer an action(s) that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a transaction risk exposure (TRE) management system in accordance with an aspect of the innovation.

FIG. 2 illustrates an example flow chart of procedures that facilitate evaluating and mitigating transaction risk in accordance with an aspect of the innovation.

FIG. 3 illustrates an example block diagram of a system that employs an analysis and aggregation component to mitigate transaction risk in accordance with aspects of the innovation.

FIG. 4 illustrates an example block diagram of an example relationship information store in accordance with an aspect of the innovation.

FIG. 5 illustrates an example block diagram of a decision engine component in accordance with an aspect of the innovation.

FIG. 6 illustrates an alternative example block diagram of a decision engine component in accordance with an aspect of the innovation.

FIG. 7 illustrates an example block diagram of a modality selector component in accordance with an aspect of the innovation.

FIG. 8 illustrates an alternative block diagram of a system that employs user interfaces to enable an entity to manage transaction risk in accordance with aspects of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

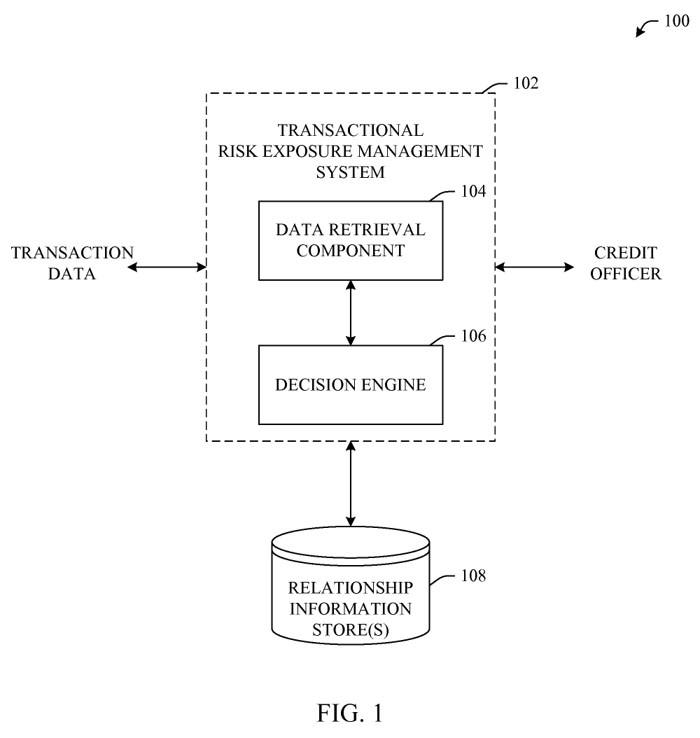

Referring initially to the drawings, FIG. 1 illustrates a system 100 that employs a transaction risk exposure (TRE) management system 102 that mitigates risk exposure to entities such as financial institutions. As shown, the TRE management system 102 of FIG. 1 can include a data retrieval component 104 and a decision engine 106. Together these sub-components facilitate real-time (or near real-time) risk awareness associated with financial transactions. As many of the examples described herein are directed to financial transactions, it is to be understood that the features, functions and benefits of the innovation can also be applied to other types of transactions and commerce without departing from the spirit and scope of the innovation. Accordingly, these alternative aspects are to be considered within the scope of this disclosure and claims appended hereto.

The TRE system 102 discloses a bank-wide repository for most all transaction risk exposure for commercial customers. It will be understood that transaction risk can occur when commercial customers transact business or commerce with a financial institution for the purpose of moving monies either into or out of the financial institution. The TRE system 102 functions as a repository for maintaining monetary exposure on customers via the accounts they use for processing monies either into or out of the financial institution.

Additionally, the TRE system 102 serves as a repository for all Borrower Default Grades (BDG) and Facility Default Grades (FDG) that are assigned to the customer and their accounts. The data retrieval component 104 can be employed to evaluate risk exposure from a variety of enterprise sources and applications thereby providing a credit officer (or other decision entity) with the requisite amount of information to make an informed decision regarding transactions and risks associated therewith.

Some features of the system 102 include the ability to accept real-time (or near real-time) and batch interfaces, performing MQ (message queue) messaging, CIM (customer interaction management) calls to other applications, calculating real time exposures, creating risk alerts, triggering electronic notifications to internal staff and external customers, automatic set up of TRE facility requests through the use of on-line request screens and approval matrices as well as real-time (or near real-time) decisioning of risk alerts.

The decision engine 106 can include logic that enables non-human intervention as it relates to approving or declining risk alerts. Additional logic can be deployed to pre-fill data values related to new or renewed requests by accessing a TRE system repository 108 as well as performing CIM calls and application extracts in acquiring pertinent data. As described above, the TRE system repository 108 (or relationship information store(s)) can be most any source ranging from a single data store to a distributed network of stores accessible from a common location.

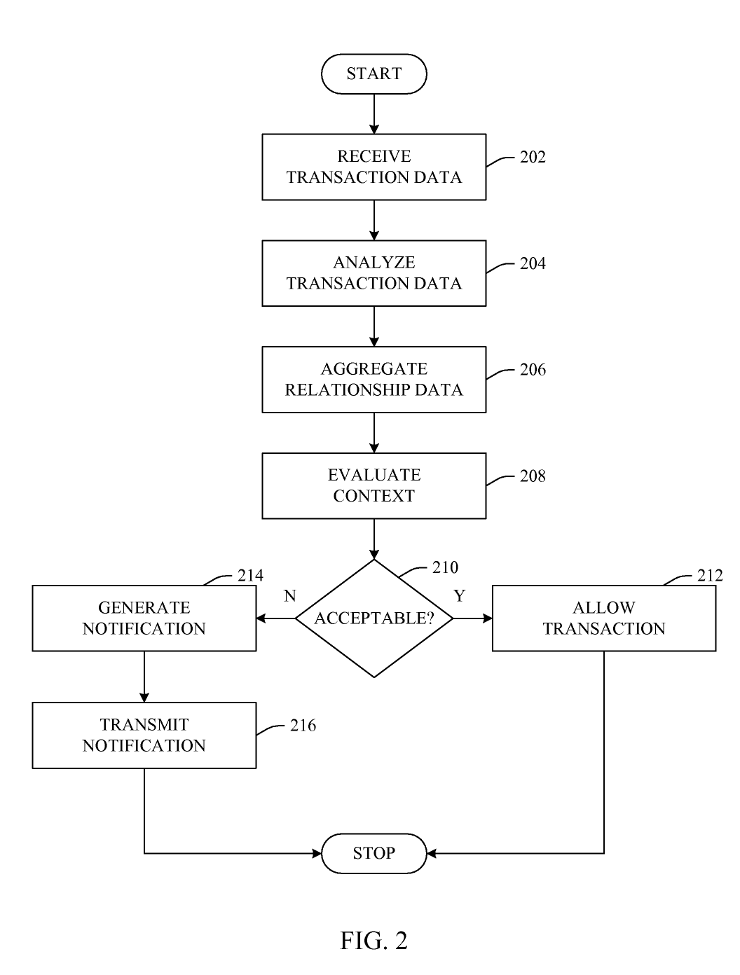

FIG. 2 illustrates a methodology of evaluating and mitigating transaction risk in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, financial transaction data is received. For example, in aspects, message traffic can be monitored in real-time (or near real-time) as well as batched scenarios. For example, user-initiated facility inputs, MQ messages, CIM calls to applications, data from interfaces (e.g., RMS (relationship management systems), TRE generated user interface(s)) or the like can be monitored. Here, this information and data can be analyzed at 204.

Accordingly, as a result of the analysis, characteristics of the data are determined, for example, context of the proposed transaction, identity of the party, etc. This information can be used to gather and aggregate relationship data at 206. In examples, the relationship data can include, but is not limited to, account information, facility information, overdraft information, group information, behavioral information, credit scores or the like. It is to be understood that most any information related to the party can be gathered without departing from the spirit and/or scope of the innovation and claims appended hereto.

The context of the situation is evaluated at 208. Here, approval/denial (e.g., decision) matrices or other rule-based mechanisms can be employed to determine if a treasury services (or other transactional) request is approved at 210. In a particular aspect, an MQ message can be transmitted which indicates if a decision is made regarding a request. If the criteria of the request are found to be acceptable at 210, at 212, the transaction is allowed and completed at 212.

However, if not acceptable at 210, at 214 a notification or alert is triggered. It will be understood that the notification or alert can be sent a customer, portfolio manager, credit officer, etc. as appropriate or desired. The alert can identify the customer name, file amount, current available balance, decision date/time, alert status, etc. It will be understood that most any appropriate and/or desired information can be included within the alert as desired. Subsequently, the alert/notification can be transmitted at 216.

In aspects, the alert/notification can be transmitted by way of electronic mail, phone, SMS (short messaging service), voice, IM (instant message), or the like. Additionally, the system permits user-definition/preference/policy with respect to recipient addresses, modality of delivery, content of message, etc. Additionally, in aspects, approval decisions can be sent via alerts and notifications in a similar manner.

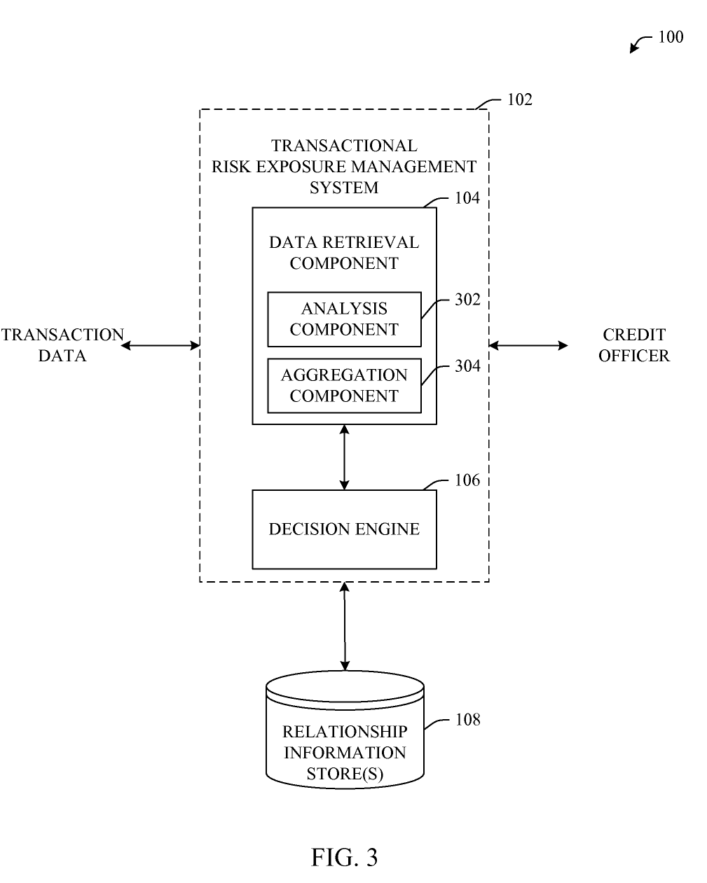

FIG. 3 illustrates an alternative block diagram of an example system 100 that facilitates mitigation of transaction risk exposure. In particular, the system 100 facilitates mitigation of transaction risk exposure by way of a repository, transactional services tracking mechanisms, alerting/notification mechanisms as well as decisioning functionality/logic. As illustrated, the data retrieval component 104 can include an analysis component 302 and an aggregation component 304. Together, these sub-components facilitate analysis of the transactional data received (e.g., from customers, loan officers . . . ). Accordingly, the analysis component 302 can extract criteria and characteristics of the transaction (or proposed transaction). These criteria can be used to retrieve relationship information from store(s) 108. For example, account balances, activity, credit limits, credit history, special circumstances, etc. can be accessed or obtained from appropriate stores 108.

The aggregation component 304 can be employed to compile the information into a format (e.g., schema) by which the decision engine 106 can process to deem the transaction accepted or otherwise flag or deny the transaction. As will be understood upon a review of the figures that follow, the decision engine 106 can be employed to trigger an alert or notification with regard to the status of the transaction service request.

In operation, the system 100 can interface with multiple systems to gather data from existing systems and applications within an organization or financial institution. An automated matrix can be employed by the decision engine 106 to automate approval/denial decisions. As such, automatic notifications and alerts can be generated and transmitted with respect to approvals, denials as well as stalled requests. Overall, the system 100 provides an ability to track end-to-end processes related to transactional services.

It is to be understood that the system 100 can provide user interfaces (UIs) by which a requestor can enter data elements. In other words, to process a new (or existing) TRE transaction, the requestor can submit transaction data that includes an account number, facility type (e.g., product sold), facility amount, purpose code (e.g., ACH (Automated Clearing House) credits/debits), credit officer's name (if known), credit application data (if known), etc. Thereafter, the analysis component 302 and the aggregation component 304 can retrieve data from the appropriate systems/stores 108. The decision engine 106 can employ matrix logic (or other appropriate logic/rules) to process the request.

In examples, the matrix defines thresholds or limits for approval. For instance, for a wholesale commercial status, a BDG of 1.5 can have a limit of $XXMM for customer ABC. Similarly, for different BDG values/ranges, limits can be specified, for example, BDG of 6.5 has a $XXMM limit. In disparate matrices, limits can be established for wholesale business banking, government banking, corporate & investment, etc. Thus, the decision engine 106 can select the appropriate matrix by which to generate a decision on a request.

Here, the TRE request will be processed via a matrix which is specific to a particular line of business. Effectively the decision engine 106 can compare the request against the appropriate matrix to determine if the requested dollar amount falls within the maximum TRE for a particular BDG (FDG—international corporate finance). If so, the request will auto-approve. It will be understood that most any auto-approval can be subject to modifications (e.g., change in approved dollar amount) by a credit officer (or other authorized individual).

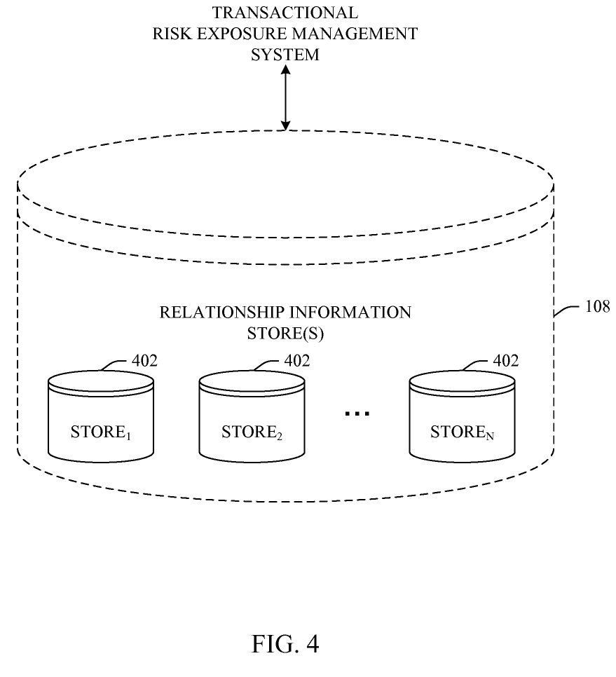

FIG. 4 illustrates a block diagram of an example relationship information store 108. As shown, the relationship information store 108 can include 1 to N stores, where N is an integer. For instance, relationship information can be distributed throughout an enterprise network as well as disparate networks. In examples, the system is capable of accessing and gathering information from third party stores. This information can be used to establish a decision whether or not to validate a treasury services request.

By way of example, third party credit histories/ratings can be employed to effect decisioning. Similarly, a financial institution is capable of communicating with other partner financial institutions in an effort to exchange information that may be relevant to treasury services decisioning. These alternative aspects are to be included within the scope of this innovation and claims appended hereto.

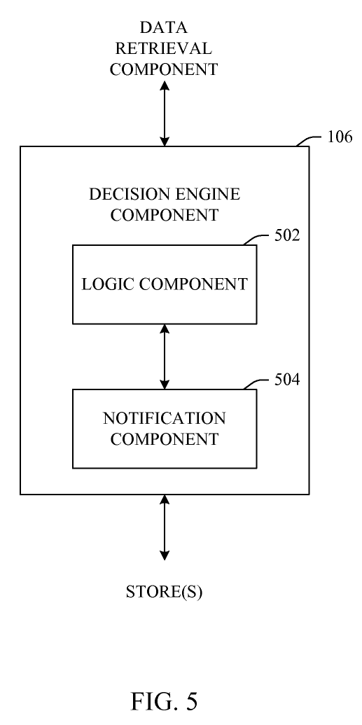

Turning now to FIG. 5, an example block diagram of a decision engine component 106 is shown. As illustrated, the decision engine component 304 can include a logic component 502 and a notification component 504. While these sub-components (502, 504) are shown inclusive of the decision engine component 106, it is to be understood that each or both of these sub-components can be located elsewhere in the system (e.g., 100 of FIG. 1) without departing from the spirit and/or scope of the innovation.

The logic component 502 can employ most any logic to establish validation, confirmation, acceptance, denial, refusal, suspension, etc. regarding treasury services requests. As will be better understood upon a review of the figures that follow, the logic component 502 can employ rules-based logic, artificial intelligence (AI), or other suitable machine learning & reasoning (MLR) logic. For instance, the approval matrix concepts described above are but one example of a rules-based logic system. In other words, the matrix can define rules (e.g., implementation schemes, thresholds) by which decisions can be made.

The notification component 504 can be employed to notify a customer, credit officer, or other appropriate and/or designated entities of activity related to treasury services requests. For instance, the notification component can send emails, SMS messages, IMs, or the like to inform of acceptances, denials, suspensions or the like. Moreover, the notification message(s) can include most any information as desired to describe, for example, nature of the request, reason for approval/denial/suspension, etc. Still further, messages can be customized so as to refrain from disclosing information which may be considered confidential in nature (e.g., account numbers, balances).

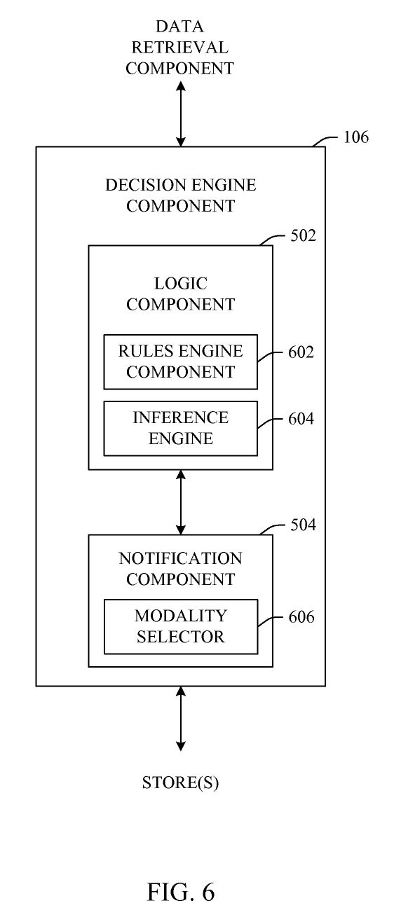

Referring now to FIG. 6, a more detailed example block diagram of decision engine component 106 is shown. As illustrated, the logic component 502 can include a rules engine component 602 and an inference engine component 604. Additionally, the notification component 504 can include a modality selector component 606. In operation, these sub-components (602-606) can be employed to automate action on behalf of a user or entity in accordance with a preference, policy, standard, or the like.

The rules engine component 602 can be employed to generate and implement procedures on behalf of a user or entity. In one aspect, the aforementioned decision matrix can be referred to as a rules-based mechanism. Here, this matrix can be explicitly or implicitly generated for or on behalf of a user.

In accordance with this alternate aspect, an implementation scheme (e.g., rule) can be applied to effect approval decisions. In response thereto, the rule-based implementation can establish decisions based upon most any desired criteria (e.g., relationship data, account type(s), account balance(s)).

Similarly, the inference engine component 604 can facilitate automating one or more features in accordance with the subject innovation. The subject innovation (e.g., in connection with approving, denying or suspending a request) can employ various AI- or MLR-based schemes for carrying out various aspects thereof. For example, a process for determining when to permit a transaction request can be facilitated via an automatic classifier system and process, for example, in view of accessible relationship data.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to approve, deny or otherwise suspend a transaction in view of a particular transaction context.

The modality selector component 606 can be employed to convey an alert or notification to an entity. Essentially, based upon most any desired factor(s), the modality selector component 606 can determine an appropriate or suitable protocol by which to transmit or convey the information. Further, the modality selector component 606 can establish distribution rules related to parties, entities, types of notifications, context, or the like.

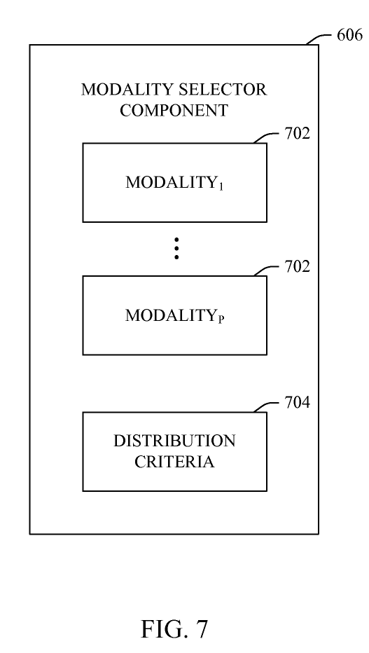

Turning now to FIG. 7, an example block diagram of a modality selector component 606 is shown. As illustrated, this selector component 606 can employ 1 to P modalities 702, where P is an integer. For instance, a modality 702 is intended to include, but is not limited to, email, SMS or text message, IM, voice call, etc. Preferences and/or policies associated with the selection of an appropriate modality can be based upon rules or inferences as described with reference to FIG. 6.

The distribution criteria component 704 can be employed to establish parameters by which information is conveyed in an alert or notification. In examples, the distribution criteria component 704 can define the types of information to disclose, the granularity of the information to disclose, when/if to mask information to protect confidentiality or unwanted/unintended disclosure, etc. Consistent with FIG. 6, it is to be understood that the distribution criteria can be based upon predefined or programmed rules as well as inferred by a suitable AI- or MLR-mechanism. These aspects are to be included within the scope of this disclosure and claims appended hereto.

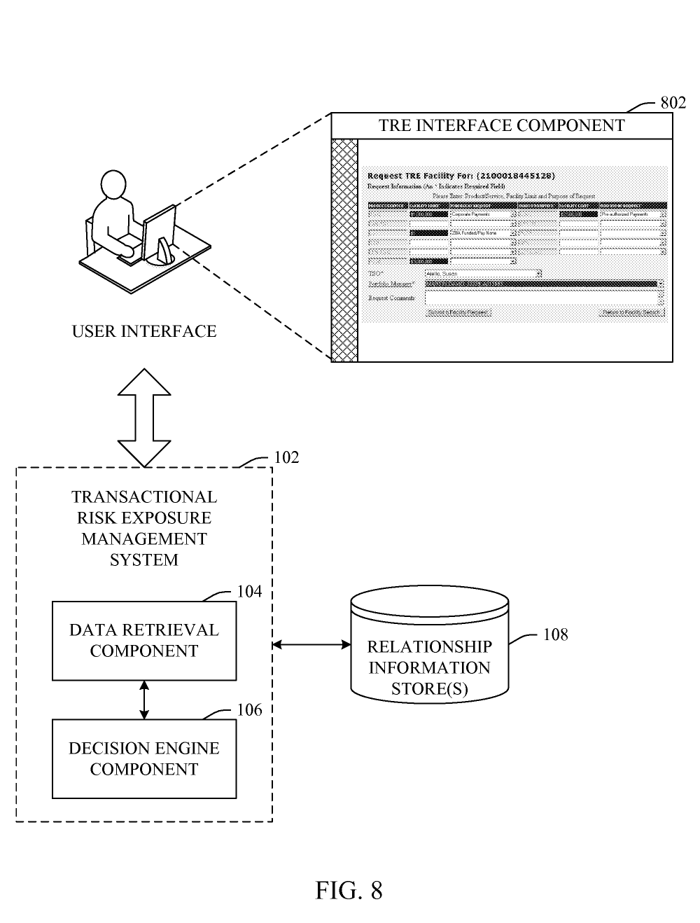

FIG. 8 illustrates an example user interface (UI) screen or page view in accordance with aspect of the innovation. It is to be understood that the example shown is provided to add perspective to the innovation and is not intended to limit the innovation in any manner. Thus, countless examples of the innovation's features, functions and benefits exist. These countless examples are to be included within the scope of this disclosure and claims appended hereto.

The figures described herein assist in understanding a matrix approval process in accordance with aspects of the innovation. As described herein, the innovation enables TRE requests to be entered into a single system. Essentially, the system (100 of FIG. 1) is capable of interfacing with multiple systems to gather data, for example, relationship data. This data can be used to effect request approval/denial/suspension, for example, by a credit officer.

In response to the automated (e.g., matrix-based) decisions, the system can provide automatic notifications on approvals, denials as well as stalled requests. Initially, an entity (e.g., treasury sales officer) can employ a UI or set of UI's to input correct data elements into the system. In accordance therewith, the entity can identify the decision makers, for instance, credit officers. These designations can be modified as desired using appropriate and suitable UI screens.

FIG. 8 illustrates an example UI 802 by which a sales officer can enter the system. In addition to entering information regarding relationships, the entity can respond to notifications, submit credit and other relationship information as well as provide usage information on renewal requests, for example. Examples of the types of information entered by the sales officer can include, but are not limited to, account numbers, facility type, facility amount, purpose code(s), credit officer name, credit application data, etc.

Once the data is entered into the system, the system (e.g., data retrieval component 104) can search for existing credit relationship information (e.g., from relationship information stores 108). Additionally, the system can check for TRE group information as well as check a matrix restricted list. Still further, the decision engine 106 can process the request by way of the appropriate credit matrix. It will be understood that the matrix approval process can provide a more efficient process for approving and/or renewing treasury services products. In aspects, matrix approved requests are the responsibility of the assigned credit officer. Below are examples of various matrices in accordance with aspects of the innovation:

| | |
|---|---|
| Matrix 1: Wholesale | Matrix 3: Government |
| Commercial and REFS | Banking |

| BDG | Limit | BDG | Limit |
|---|---|---|---|
| XX | $XXMM | XX | $XXMM |
| XX-XX | $XXMM | XX-XX | $XXMM |
| XX-XX | $XXMM | XX-XX | $XXMM |
| XX-XX | $XXMM | XX-XX | $XXMM |
| XX-XX | $XXMM | XX-XX | $XXMM |
| XX | $XXMM | XX | $XXMM |
| XX | $XXMM | XX | $XXMM |

| Matrix 2: Wholesale Business | | | |
|---|---|---|---|
| Banking Banking: | | Matrix 4: Corporate & | |
| Community & Wealth | | Investment | |
| BDG | Limit | BDG/FDG for Intl | Limit |
| XX | $XXMM | XX | $XXMM |
| XX-XX | $XXMM | XX | $XXMM |
| XX-XX | $XXMM | XX | $XXMM |
| XX-XX | $XXMM | XX | $XXMM |
| XX-XX | $XXMM | XX | $XXMM |
| XX | $XXM | XX | $XXMM |
| XX | $XXM | XX | $XXMM |

In operation, the entity can employ UIs to enter identifying information such as login and password credentials to gain access to the TRE system. Once access is gained, a TRE facility request and facility modifications can be selected to open a new facility. Here, account numbers and other identification parameters can be entered. Subsequently, information such as requested limits, purposes, credit officer selection, etc. can be input by the entity.

Thereafter, the TRE request can be automatically evaluated, for example, as a function of a matrix as described above. Thus, approvals can be posted onto the system. Similarly, approvals, denials and suspensions can be sent by way of notifications to most any designated parties, for example, sales, credit officers, etc.

If approved, the new facility is processed. If not approved, for example, by the matrix, the request is considered a pending request in the TRE system. For instance, the pending request can be routed to the designated credit officer's in-box for normal (e.g., manual) processing. In aspects, if the request is not decisioned within a set number of days, reminders can be sent by way of the selected modality. Once approved, an approval notification can be sent. Stalled or suspended requests are processed in similar manners. In other words, if deem stalled by the matrix, notifications can be sent to both the sales and credit officers for action. Here, the system can aggregate relationship information and provide the information to the appropriate (or designated) entities to effect efficient decisioning.

In addition to entering information, the UIs can be used to query for pending requests as well as to change criteria, for example, credit officer designations. For instance, UIs can be used to review new credit requests that fail the matrix approval process, facility requests that have passed the matrix approval process, facility renewals that fail the credit matrix process, facility increases or decreases that fail the credit matrix, facility requests that have been declined, credit officer changes, among others.

As described in detail above, in aspects, the TRE system (e.g., system 100 of FIG. 1) can represent a bank-wide repository for most all transaction risk exposure for commercial customers. It will be understood that transaction risk occurs when commercial customers transact business/commerce with the financial institution for the purpose of moving monies either in to or out of the financial institution. One motivation for the TRE risk system of the innovation is to act as a repository for maintaining monetary exposure on customers via the accounts they use for processing monies either into or out of a financial institution.

Additionally, in aspects, the TRE risk system serves as a repository for all BDG and FDG that are assigned to a customer and their accounts. Features of the system include the ability to accept real-time (or near real-time) and batch interfaces, performing MQ messaging, CIM calls to other applications, calculating real time exposures, creating risk alerts, triggering electronic notifications to internal staff and external customers, automatic set up of TRE facility requests through the use of on-line request screens and approval matrices as well as real-time decisioning of risk alerts. Extensive logic can be incorporated to enable non-human intervention as it relates to approving or declining risk alerts. Additional logic can be deployed to pre-fill data values on new or renewed request by accessing the TRE risk system repository as well as performing CIM calls and application extracts in acquiring the pertinent data

The business process of the innovation allows risk management staff within a financial institution to effectively and efficiently, establish, monitor and act upon transaction risks that may occur. The process can entail establishing a unique customer, their account relationships with the bank, assigning transactional exposure limits, monitoring those limits, notifying appropriate (or desired) personnel when limits are breached, and notifying customers as appropriate. The innovation can mitigate financial risk to financial institutions that engage in commercial customer transactions as they perform business/commerce with their financial institution for the purpose of moving monies either in to or out of the financial institution.

The innovation is useful in assisting financial institutions to limit losses that can occur when commercial customers transact business/commerce with other parties either in or outside of the financial institution. This innovation gives financial institutions the ability to store, maintain, monitor and control transaction risk across their multiple commercial customer segments. As used herein, ‘commercial customer’ is intended to include Business Banking, Small Business, Relationship Banking, Commercial Banking, Corporate Banking, Wealth Banking and all other commercial endeavors that are not construed as being part of personal or retail banking.

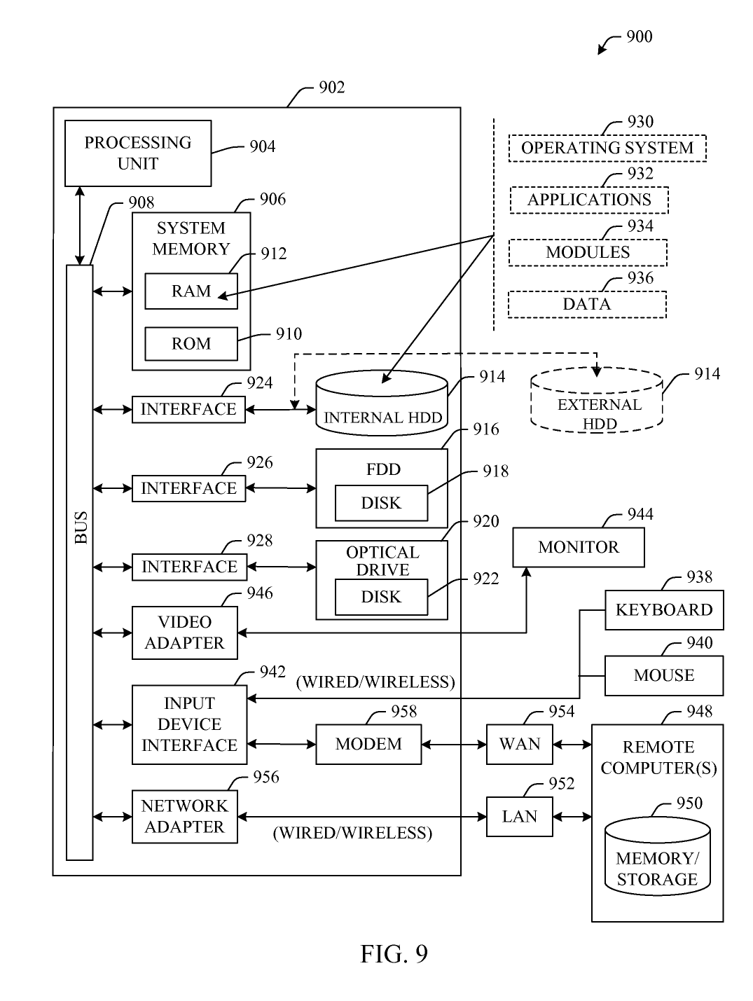

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

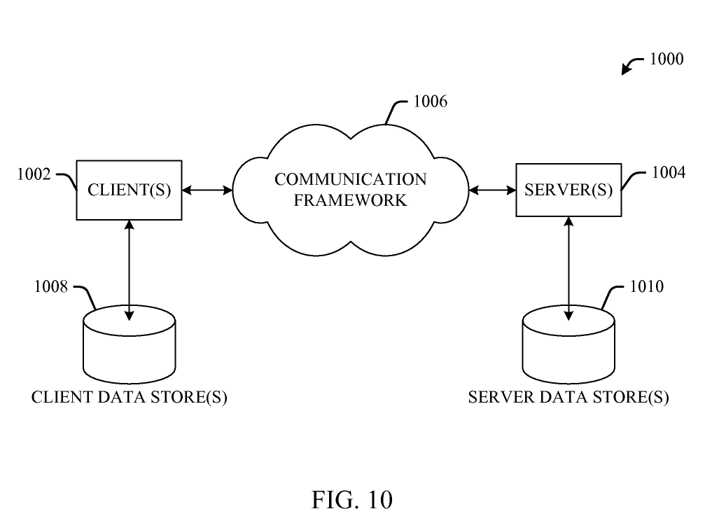

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates management of transaction services risk, comprising:
a data retrieval component that accepts transactional data that represents a transaction request, wherein the data retrieval component accesses relationship data associated with the transaction request; and
a decision engine that automatically determines at least one of approval, denial or suspension of the transaction request based at least in part upon a subset of the relationship data.

2. The system of claim 1, wherein the transaction request is an automated clearinghouse (ACH) request.

3. The system of claim 1, wherein the relationship data is retrieved from a plurality of relationship sources.

4. The system of claim 1, wherein the relationship data includes at least two of account number, account balance, account type, facility type, facility amount, purpose code, transaction history or credit history.

5. The system of claim 1, further comprising an analysis component that evaluated the transaction request and determines a plurality of sources for the relationship data.

6. The system of claim 1, further comprising an aggregation component that consolidates relationship data elements to establish the relationship data, wherein each of the relationship data elements is associated with a requester of the transaction request.

7. The system of claim 1, further comprising a logic component that automatically determines approval, denial or suspension of the transaction request.

8. The system of claim 8, wherein the logic component employs a matrix to establish approval, denial or suspension of the transaction request.

9. The system of claim 8, further comprising a rules engine component that employs an implementation scheme to establish approval, denial or suspension of the transaction request.

10. The system of claim 8, further comprising an inference engine that employs at least one of a probabilistic and a statistical-based analysis that infers an action that a user desires to be automatically performed.

11. The system of claim 1, further comprising a notification component that generates and delivers an alert to an entity, wherein the alert conveys at least one of approval, denial or suspension of the transaction request.

12. The system of claim 11, further comprising a modality selector component that determines an appropriate modality for delivery of the alert.

13. The system of claim 12, wherein the appropriate modality is at least one of email, SMS (short message service), or instant message (IM).

14. The system of claim 1, further comprising a user interface that facilitates generation and delivery of the transaction request.

15. A computer-implemented method of managing transaction risk, comprising:
receiving a transaction request;
evaluating the transaction request based upon an approval matrix; and
determining at least one of approval, denial or suspension of the transaction request based upon the evaluation.

16. The computer-implemented method of claim 15, further comprising notifying a party of the at least one of approval, denial or suspension of the transaction request.

17. The computer-implemented method of claim 15, further comprising aggregating relationship data based upon the evaluation and delivering the relationship data to a decisioning entity that is capable of overriding the approval, denial or suspension based upon the relationship data.

18. The computer-implemented method of claim 15, further comprising selecting the approval matrix from a plurality of approval matrices, wherein the selection is based upon characteristics of the transaction request.

19. A computer-executable system of managing risk, comprising:
means for receiving a transaction request;
means for analyzing the transaction request to establish request-specific criteria, wherein the request-specific criteria at least includes transaction type and transaction amount;
means for evaluating the transaction request based at least in part upon a subset of the request-specific criteria in view of an approval matrix; and
means for conveying a result of the evaluation to an entity.

20. The computer-executable system of claim 19, further comprising means for selecting the approval matrix from a plurality of matrices based at least in part upon a subset of the request-specific criteria.
